(19) United States
(12) Patent Application Publication
(10) Pub. No.: US 2014/0199112 A1
(43) Pub. Date: Jul. 17, 2014

(54) CONNECTION FIXTURE

(71) Applicants: Wayne Milner, Burnside Hts. (AU); Rudy Diener, Doonside (AU)

(72) Inventors: Wayne Milner, Burnside Hts. (AU); Rudy Diener, Doonside (AU)

(21) Appl. No.: 14/127,678

(22) PCT Filed: Nov. 25, 2011
(86) PCT No.: PCT/AU2011/001515

§ 371 Date: Mar. 19, 2014

(30) Foreign Application Priority Data
Jun. 29, 2011 (AU) 2011902570

(51) Int. Cl. F16C 11/04; E04F 11/18; E04H 17/14

(52) U.S. Cl. CPC F16C 11/04; E04H 17/14; E04F 11/18
USPC 403/72

(57) ABSTRACT

A connection fixture (10) for interconnecting at least two tubular members (18, 20), the connection fixture (10) including: a mounting fixture (18) configured to be secured around a section of a first tubular member, the mounting fixture (18) including a first connection section (30) including a first connection aperture (36, 37); at least one receiving element (20) configured to receive an end section of a second tubular member, each receiving element (20) including a second connection section (45) including a second connection aperture (46); and at least one connector (22) configured to be received through the first connection aperture (36, 37) and the second connection aperture (46) of at least one of the receiving elements (20) to secure that receiving element (20) to the mounting fixture (18), and allow the receiving elements (20) to pivot relative to the mounting fixture (18), wherein each mounting fixture (18) and receiving element (20) include: at least one threaded fastening aperture (28, 53) configured to receive a threaded fastener (31) for friction fitting the respective mounting fixture (18) or receiving element (20) to the respective first tubular member or second tubular member; and at least one fixing aperture (33, 54) configured to receive a fixing element which forms a mechanical connection between the respective mounting fixture (18) or receiving element (20) to the respective first tubular member or second tubular member.

### FIELD OF THE INVENTION

The present invention generally relates to a connection fixture. The invention is particularly applicable as an adjustable connection fixture for interconnecting tubular members of a fence structure or tubular railing sections of a hand rail and it can be convenient to hereinafter disclose the invention in relation to that exemplary application. However, it is to be appreciated that the invention is not limited to that application and could be used for connecting tubular sections in various other structures such as balustrades, railings, hand rails, or the like.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Metal tubular fences and tubular hand rails are constructed from a plurality of tubular pipes which are interconnected using connection fixtures. A number of adjustable connection fixtures are currently available on the market, including connection fixtures taught in the applicant's international publication WO2009/126989A1 and Australian Design Registration No. 328482.

Each of these prior connection fixtures are fixed to the end of a tubular pipe using a flat ended threaded fastener which is received in a correspondingly threaded fastening opening and is screwed therein so that the flat end of the threaded fastener tightly abuts the end of the tubular pipe received in the respective connection fixture. This forms a strong friction fit between the connection fixture and the tubular pipe.

The Applicant has found that this connection arrangement can be unsuitable in certain applications, as a friction fit can be loosened over time enabling the tubular pipes to move and in some instances come free from the connection fixture. In metal fences, this can pose a safety threat, as the stability of the fence structure can be compromised.

It is therefore desirable to provide an alternative connection fixture which can be more securely fastened to a tubular pipe received therein.

### SUMMARY OF THE INVENTION

According to the present invention, there is provided a connection fixture for interconnecting at least two tubular members, the connection fixture including:

a mounting fixture configured to be secured around a section of a first tubular member, the mounting fixture including a first connection section including a first connection aperture;

at least one receiving element configured to receive an end section of a second tubular member, each receiving element including a second connection section including a second connection aperture; and

at least one connector configured to be received through the first connection aperture and the second connection aperture of at least one of the receiving elements to secure that receiving element to the mounting fixture, and allow the receiving elements to pivot relative to the mounting fixture,

wherein each mounting fixture and receiving element include: at least one threaded fastening aperture configured to receive a threaded fastener for friction fitting the respective mounting fixture or receiving element to the respective first tubular member or second tubular member; and

at least one fixing aperture configured to receive a fixing element which forms a mechanical connection between the respective mounting fixture or receiving element to the respective first tubular member or second tubular member.

The use of two different types of connection arrangements enable a user to more easily and fixedly connect together two different tubular members. In this respect, the fastening aperture can be used to initially friction fit together the fence or railing structure. Once the overall structure is erected, the tubular members can be physically joined to the connectors using the fixing aperture.

It is to be understood that the mechanical connection formed in the fixing aperture between the respective mounting fixture or receiving element to the respective first tubular member or second tubular member is to form a physical connection or join which mechanically links the two parts. This mechanical connection can be formed by a bolt, screw, rivet, weld, hook type connection, wire, chains, clips, snap fit fixtures or the like. In a preferred form, the mechanical connection comprises a tek screw and/or a weld.

Any number of fixing apertures and fastening apertures can be used in the mounting fixture and receiving element of the connection fixture. In some embodiments, the mounting fixture includes at least two fixing apertures. In some embodiments, the mounting fixture can includes at least two fastening apertures.

The mounting fixture and receiving elements can have any shape or configuration. In a preferred form, each of the mounting fixture and receiving elements include substantially tubular bodies including a central axis. In such embodiments, the respective fixing apertures or fastening apertures can be axially aligned relative to the respective central axis. Similarly, the fixing apertures of the mounting fixture can be annularly spaced apart from the fastening apertures of the mounting fixture relative to the central axis thereof. In one embodiment, the respective fixing apertures and fastening apertures of the mounting fixture are spaced apart about the first connection section. However, it should be appreciated that the fixing apertures or fastening apertures can be located in any other suitable position.

The fixing aperture and fastening aperture can have any suitable configuration and size. In some embodiments, one or both of the fixing apertures and fastening apertures have a substantially circular cross-section. In other embodiments, the fixing aperture has a polygonal cross-section. The relative size of the apertures depends on the intended fastening element or component being received or located in that element. In one embodiment, the average size of the fixing apertures is generally the same as the average size of the fastening apertures. In other embodiments, the average size of the fixing apertures is smaller than the average size of the fastening apertures. In yet other embodiments, the average size of the fixing apertures is larger than the average size of the fastening apertures. Each of the fastening apertures and fixing apertures can be threaded. In a preferred embodiment, the fixing apertures are unthreaded.

The connection fixture of the present invention can further include one threaded fastener and complementary security cap configured to be received in a threaded fastening aperture of a mounting fixture or receiving element. The fastener has a head with an engagement recess. The security cap can therefore be configured to plug the engagement recess of the fastener. This provides a security feature which deters, and in some cases, substantially prevents the fastener from being removed from the fastening aperture once received and fastened therein. The engagement recess of the fastener can have any suitable configuration. In one embodiment, the engagement recess comprises a polygonal shaped recess. Suitable polygon shapes include, star, hexagonal, square, triangle, octagonal or the like. The security cap preferably includes shaped section configured to be inserted and securely retained within the engagement recess. In some instances, the shaped section can have a complementary shape to the engagement recess. In other instances, the shaped section can have a shape which has an interference fit with the engagement recess. For example, where the engagement recess is hexagonal, the shaped section can have a circular cross-section of a diameter which wedges into the engagement recess. The shaped section of the security cap is typically a shaft. The security cap is preferably securely fixed within the engagement recess, for example using an adhesive.

The first connection section and second connection section can have any suitable configuration. In one embodiment, the connection sections comprise a protrusion. In other embodiments, the connection section comprises a band. In a preferred embodiment, each of the first connection section and second connection section comprise a flange. In this embodiment, the connector extends perpendicularly through the first and second connection apertures relative to the flange providing a pivot about which the mounting fixture and receiving element can pivot relative to one another.

The connector can comprise any suitable connector or fastening arrangement which can extend through and connect the first connection section and the second connection section. In one embodiment, the connector comprises a nut and bolt arrangement, the nut including an elongate shaft which extends through the apertures of the first connection section and the second connection section. Where the first connection section and the second connection section comprise a flange, nut of the connector can in some embodiments be mounted to, fixed to, or integrally formed with one of the flanges of the first connection section. In use, this enables easy assembly of the respective receiving element to the mounting element, as the user does not need to manipulate both the bolt and nut.

Some embodiments of the connection fixture according to the present invention can be configured to mount a receiving element thereon in a number of different locations. Accordingly, some embodiments of the connection fixture include a mounting fixture that includes at least two first connection sections. These embodiments could include at least two receiving elements. Each receiving element would be configured to receive an end section of a tubular member and could be fastened to the mounting fixture using a cooperating connector. Accordingly, the position of each of the at least two receiving elements could be selected to suit a particular connection configuration between three or more tubular members.

The connection fixture of the present invention can be used to connect a variety of different types of tubular members. Suitable tubular members include metal or wooden members including poles, posts, struts, beams, sections, arches or the like. In a preferred embodiment, each of the tubular members comprises tubular poles. The tubular poles could have any suitable cross-section including circular, square, rectangular or the like.

### BRIEF DESCRIPTION OF THE DRAWINGS

The present invention can now be described with reference to the figures of the accompanying drawings, which illustrate particular preferred embodiments of the present invention, wherein:

FIG. 1 is a first isometric view of a connection fixture according to a first embodiment of the present invention when viewed from above.

FIG. 2 is a further isometric view of the connection fixture of FIG. 1 when viewed from below.

FIG. 3A is a front elevation view of the connection fixture of FIG. 1.

FIG. 3c is a side elevation view of the connection fixture of FIG. 1.

FIG. 3C is a base view of the connection fixture of FIG. 1.

FIG. 4 is an isometric exploded view of the of the connection fixture of FIG. 1.

### DETAILED DESCRIPTION

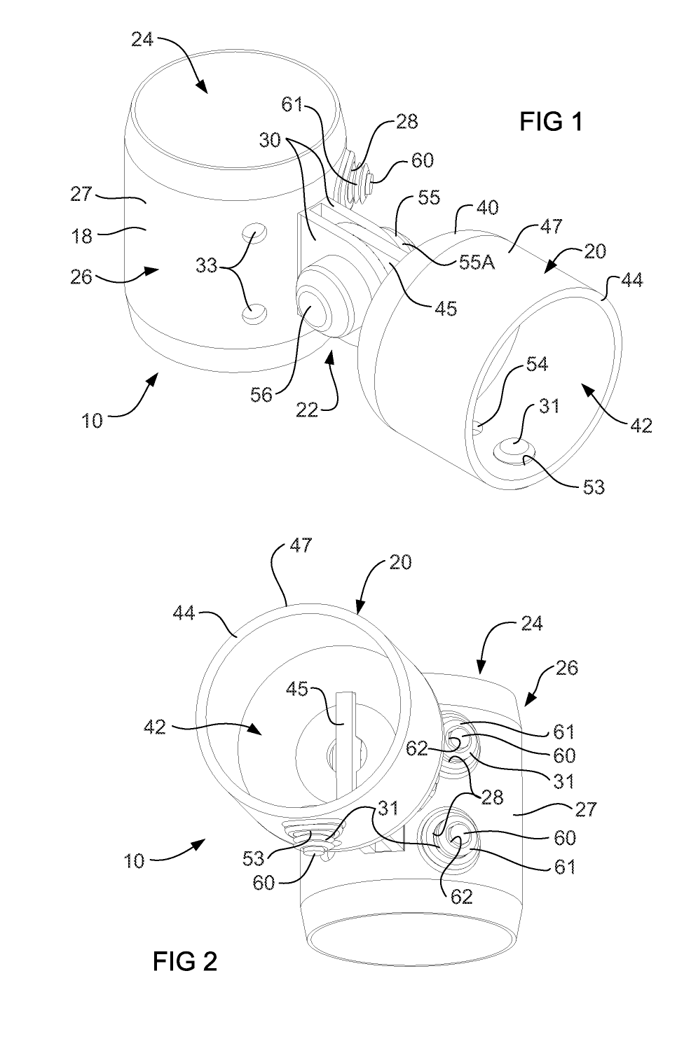

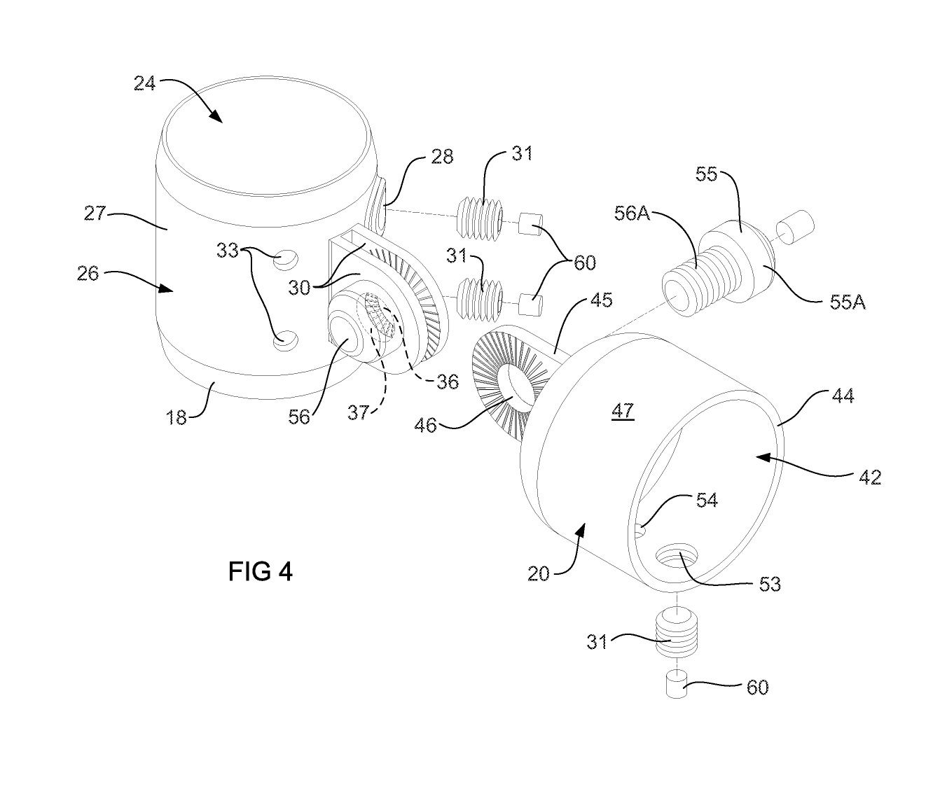

FIGS. 1 to 4 illustrate a connection fixture 10 according to a one embodiment of the present invention. FIGS. 1 to 3 show the connection fixture 10 as assembled. FIG. 4 shows an exploded view of the connection fixture 10 disassembled in its component parts.

The illustrated connection fixture 10 includes three interconnected sections, being a mounting fixture 18, a receiving element 20 and a connector 22.

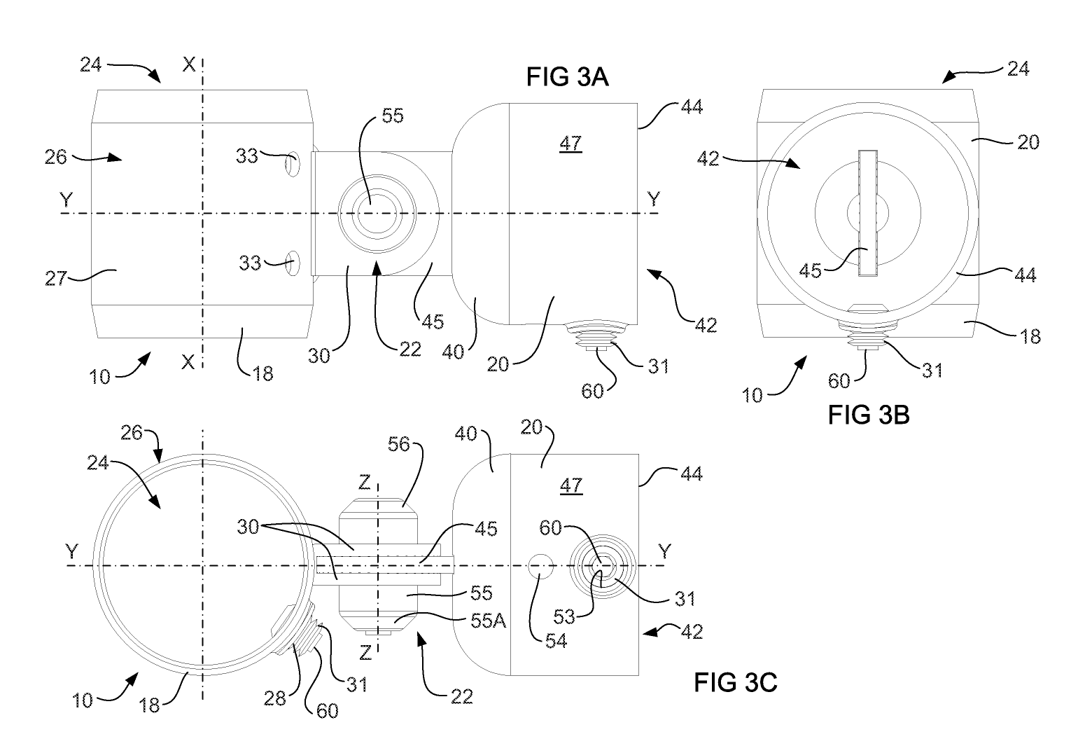

The illustrated mounting fixture 18 is a tubular collar configured to be fastened around a section of a tubular member, such as tubular pole (not shown). In this regard, the mounting fixture 18 includes a central opening 24 through which a tubular member such as pole can be received. The mounting fixture includes a tubular hub section 26 having tubular walls 27 configured to encircle and substantially abut with the outer surface of a tubular pole received within the central opening 24. The illustrated mounting fixture 18 also includes two spaced apart connection flanges 30 which extend radially outwardly relative to axis X-X of the tubular hub 26. Each flange 30 includes a first connection aperture 36, 37 which run along pivot axis Z-Z (FIG. 3C) configured to receive the connector 22 therethrough.

The hub section 26 of the mounting fixture 18 includes two types of connection apertures circumferentially spaced apart about the connection flanges 30. Firstly, two threaded fastening holes 28 (best shown in FIG. 4) are provided on one side of the connection flanges 30 through which a flat headed threaded fastener 31 (best illustrated in FIG. 4) can be inserted to fasten the mounting fixture 18 to a tubular pole received within the central opening 24. This threaded fastener 31 functions to friction fit the respective mounting fixture 18 to that tubular pole. Secondly, two threaded fixing holes 33 are provided on the opposite side of the connection flanges 30 through which a tek screw and/or a weld (not illustrated) can be inserted to fix the mounting fixture 18 to a tubular pole received within the central opening 24. The fixing hole 33 is not threaded. The fixing holes 33 are provided to insert a fixing element (tek screw or weld) which forms a mechanical connection between the respective mounting fixture 18 to that tubular pole. Each of the respective fastening holes 28 and fixing holes 33 are axially aligned relative to the respective central axis X-X on either side of the connection flanges 30.

The receiving element 20 is a cup shaped body having a hemispherical end 40 and an opening 42 at the other end 44. Central axis Y-Y (FIG. 3A and 3C) runs through the centre of the receiving element 20. The receiving element 20 also includes a sleeve section 47 configured to receive and seat an end section of a tubular member, such a pole (not illustrated). In this respect, an end section of a pole can be inserted through the opening 42 and seated within the sleeve section 47. The hemispherical end 40 includes a flange 45 which extend perpendicularly from the outer surface of the apex of the hemispherical end 40. The flange 45 includes a second connection aperture 46 configured to receive the connector 22 therethrough. The flange 45 is configured to be received between the spaced apart flanges 30 of the mounting fixture 18.

Like the mounting fixture 18, the sleeve section 47 of the receiving element 20 includes two types of connection apertures, in this case axially aligned with central axis Y-Y on the sleeve section 47. Firstly, a threaded fastening hole 53 (best shown in FIG. 4) is provided through which a flat headed threaded fastener 31 (FIGS. 1 and 2) can be inserted to fasten the receiving element 20 to a tubular pole received within the central opening 42. This threaded fastener 31 functions to friction fit the respective receiving element 20 to that tubular pole. Secondly, a fixing holes 54 is provided through which a tek screw and/or a weld (not illustrated) can be inserted to fix the receiving element 20 to a tubular pole received within the central opening 42. The fixing hole 54 is not threaded. The fixing holes 54 is provided to insert a fixing element (tek screw or weld) which forms a mechanical connection between the respective mounting fixture 18 to that tubular pole.

The connector 22 (best shown in FIG. 4) is used to fasten the receiving element 20 to the mounting fixture 18. The illustrated connector 22 is a bolt 55A and nut 56 fastener which includes an elongate threaded central shaft 56A having a substantially hemispherical bolt head 55 at one end and a substantially hemispherical retaining nut 56 which fastens over the distal end of the elongate central shaft. The threaded shaft 56A cooperates with a retaining nut 56 to form a clamping end for the connector 22. The connector 22 acts as a pivot about and around which the mounting fixture 18 and receiving element 20 can move relative to each other. In the illustrated embodiment, the retaining nut 56 is fixed (welded, integrally formed or the like) to the proximate connection flange 30. This allows easy insertion and fastening of the bolt 55A and nut 56 when the connection fixture 10 is in use.

The mounting fixture 18, receiving element 20 and connector 22 are assembled to form the connection fixture 10 by inserting the flange 45 of the receiving element 20 between the flanges 30 of the mounting fixture 18 and aligning the first and second connection apertures. The bolt 55A of the connector 22 is then inserted into the first 36, 37 and second 46 connection apertures, and into the retaining nut 56 is tightened so as to clamp the receiving element 20 to the mounting fixture 18.

It should be appreciated that the mounting fixture 18 could include any number of pairs of spaced apart flanges 50, 52 attached and spaced apart around the periphery of the mounting fixture 18 for attaching multiple receiving elements 20.

The threaded fastener 31 used in the threaded fastening holes 28 and 33 of the mounting fixture 18 and/or receiving element 20 can include a security cap 60. Each of the illustrated threaded fasteners 31 has a head 61 with a hexagonally shaped engagement recess 62. As shown in FIGS. 1 to 3, each security cap 60 is configured to fit into the engagement recess 62 of the fastener 31, and therefore impede a tool being inserted into that recess 62, thereby substantially preventing the fastener 31 being manipulated and removed from fastening holes 28 and 33 once received and fastened therein. Each security cap 60 has a shaped plug shaft 64 which is configured to securely fit within the hexagonally shaped engagement recess 62 (best illustrated in FIGS. 2 and 3C) of the fastener 31. In the illustrated embodiment, the plug shaft 64 has a tubular shape (best illustrated in FIGS. 3C and 4), sized to friction fit within the hexagonally shaped engagement recess 62. However, it should be appreciated that in other embodiments the plug shaft 64 could have other cross-sectional shapes, for example a complimentary hexagonal shape. In some embodiments, the plug shaft 64 of the security cap 60 can be securely fixed within the engagement recess 62 using adhesive.

Each of the mounting fixture 18, receiving element 20 and connector 22 can be manufactured using a number of different techniques. The components of the illustrated embodiment are pressure cast products, produced using suitable injection die casting techniques. However, it should be appreciated that the components could be manufactured using other techniques such as stamping, pressing techniques or the like.

The illustrated connection fixture 10 can replace most existing standard fittings, such as tee fixtures, cross fixtures and corner fixtures in barrier structures such as fences, balustrades, railings, hand rails, or the like. In this respect, a user can use the adjustability of the connection fixture 10 to move to the receiving element 20 at a selected angle relative to the mounting fixture 18 corresponding to the equivalent tee fixture, cross fixture and/or corner fixture.

Those skilled in the art can appreciate that the invention described herein is susceptible to variations and modifications other than those specifically described. It is understood that the invention includes all such variations and modifications which fall within the spirit and scope of the present invention.

Throughout the description and claims of the specification the word “comprise” and variations of the word, such as “comprising” and “comprises”, is not intended to exclude other additives, components, integers or steps.

1.-20. (canceled)

21. A connection fixture for interconnecting at least two tubular members, the connection fixture including:
a mounting fixture configured to be secured around a section of a first tubular member, the mounting fixture including a first connection section including a first connection aperture;
at least one receiving element configured to receive an end section of a second tubular member, each receiving element including a second connection section including a second connection aperture; and
at least one connector configured to be received through the first connection aperture and the second connection aperture of at least one of the receiving elements to secure that receiving element to the mounting fixture, and allow the receiving elements to pivot relative to the mounting fixture,
wherein each mounting fixture and receiving element include:
at least one threaded fastening aperture configured to receive a threaded fastener for friction fitting the respective mounting fixture or receiving element to the respective first tubular member or second tubular member; and
at least one fixing aperture configured to receive a fixing element which forms a mechanical connection between the respective mounting fixture or receiving element to the respective first tubular member or second tubular member.

22. A connection fixture according to claim 21, wherein the mechanical connection comprises a bolt, screw, rivet, weld, or hook type connection.

23. A connection fixture according to claim 22, wherein the mechanical connection comprises a tek screw.

24. A connection fixture according to claim 21, wherein the mounting fixture includes at least two fixing apertures.

25. A connection fixture according to claim 21, wherein the mounting fixture includes at least two fastening apertures.

26. A connection fixture according to claim 21, wherein each of the mounting fixture and receiving elements include substantially tubular bodies including a central axis.

27. A connection fixture according to claim 26, wherein the respective fixing apertures or fastening apertures are axially aligned relative to the respective central axis.

28. A connection fixture according to claim 27, wherein the fixing apertures of the mounting fixture are annularly spaced apart from the fastening apertures of the mounting fixture relative to the central axis thereof.

29. A connection fixture according to claim 21, wherein the respective fixing apertures and fastening apertures of the mounting fixture are spaced apart about the first connection section.

30. A connection fixture according to claim 21, wherein the average size of the fixing apertures is smaller than the average size of the fastening apertures.

31. A connection fixture according to claim 21, wherein the fixing apertures have a substantially circular cross-section.

32. A connection fixture according to claim 21, wherein the fixing apertures are unthreaded.

33. A connection fixture according to claim 21, further including at least one threaded fastener and complementary security cap configured to be received in a threaded fastening aperture of a mounting fixture or receiving element, the fastener having a head with an engagement recess, the security cap being configured to plug the engagement recess of the fastener.

34. A connection fixture according to claim 33, wherein the engagement recess comprises a polygonal shaped recess, preferably hexagonal.

35. A connection fixture according to claim 33, wherein the security cap includes a section configured to be inserted and securely retained within the engagement recess.

36. A connection fixture according to claim 21, wherein each of the first connection section and second connection section comprise a flange.

37. A connection fixture according to claim 36, wherein the connector extends perpendicularly through the first and second connection apertures relative to the flanges.

38. A connection fixture according to claim 21, wherein the mounting fixture includes at least two first connection sections.

39. A connection fixture according to claim 38, further including at least two receiving elements, each receiving element configured to receive an end section of a tubular member, each receiving element being fastened to the mounting fixture using a cooperating connector.

40. A connection fixture according to claim 21, wherein each of the tubular members comprise tubular poles.
